(19) United States
(12) Patent Application Publication
(10) Pub. No.: US 2014/0077692 A1
(43) Pub. Date: Mar. 20, 2014

(54) FLAT PANEL DISPLAY DEVICE HAVING THIN FILM ENCAPSULATION AND, MANUFACTURING METHOD THEREOF

(71) Applicant: SAMSUNG DISPLAY CO., LTD., Yongin-si (KR)

(72) Inventor: Keun-Soo Lee, Yongin-City (KR)

(73) Assignee: SAMSUNG DISPLAY CO., LTD., Yongin-si (KR)

(21) Appl. No.: 13/794,435

(22) Filed: Mar. 11, 2013

(30) Foreign Application Priority Data
Sep. 18, 2012 (KR) 10-2012-0103616

(51) Int. Cl. H05B 33/10; H05B 33/04

(52) U.S. Cl. CPC H05B 33/10; H05B 33/04
USPC 313/512; 445/25

(57) ABSTRACT

A flat panel display device and a manufacturing method thereof. In the flat panel display device, a thin film encapsulation structure covering a display unit on a substrate includes an alternating layers stack in which organic layers and inorganic layers are alternately stacked; and an AlOx layer on the alternating layers stack as an outermost thin film layer of the thin film encapsulation structure. According to the above structure, because the protective film is adhered onto the AlOx layer of the thin film encapsulation structure, which has a relatively weak adhesive force, the adhering and releasing processes may be performed smoothly, and thus, the thin film encapsulation structure may be prevented from being damaged in the adhering and releasing processes.

### CROSS-REFERENCE TO RELATED PATENT APPLICATION

This application claims priority to and the benefit of Korean Patent Application No. 10-2012-0103616, filed on Sep. 18, 2012, in the Korean Intellectual Property Office, the disclosure of which is incorporated herein in its entirety by reference.

### BACKGROUND

1. Field

Aspects of the present invention relate to a flat panel display device and a manufacturing method thereof, and more particularly, to a flat panel display device including a thin film encapsulation structure and a manufacturing method thereof.

2. Description of the Related Art

Flat panel display devices, such as organic light-emitting display devices, may be manufactured to be thin and flexible, and research is being actively conducted on them.

In organic light-emitting display devices, a display unit deteriorates due to penetration of oxygen or moisture. Accordingly, in order to prevent penetration of oxygen or moisture from an external environment, an encapsulation structure for sealing and protecting a display unit is typically used.

A thin film encapsulation structure for covering a display unit with a multi-layer structure (in which organic layers and inorganic layers are alternately stacked) may be used as an encapsulation structure. The display unit is sealed by the alternately stacked organic and inorganic layers.

Here, in general, the organic layers provide flexibility to a flat panel display device and the inorganic layers prevent penetration of oxygen or moisture.

After the thin film encapsulation structure is formed in a manufacturing process, a protective film may be adhered thereon, and then, the protective film may be released in a subsequent process, for example, a process for bonding a polarizing plate. However, in this case, if the protective film is not released smoothly, the thin film encapsulation structure may also be released, and thus, its encapsulation function may be reduced.

Accordingly, a solution for preventing the above phenomenon when a protective film is released is desired.

### SUMMARY

One or more embodiments of the present invention provide a flat panel display device including a thin film encapsulation structure located thereon and from which a protective film is smoothly and appropriately (or suitably) adhered and released, and a manufacturing method thereof.

According to an aspect of the present invention, there is provided a flat panel display device including: a substrate; a display unit on the substrate; and a thin film encapsulation structure including a plurality of thin film layers covering the display unit. Here, the thin film layers of the thin film encapsulation structure include: an alternating layers stack including alternately stacked organic layers and inorganic layers; and an aluminum oxide (AlOx) layer on the alternating layers stack, the AlOx layer being an outermost thin film layer of the thin film encapsulation structure.

The inorganic layers may include silicon nitride (SiNx).

The inorganic layer including SiNx may be an outermost layer of the alternating layers stack, and the AlOx layer may be on the outermost layer of the alternating layers stack.

A polarizing plate may be bonded onto the AlOx layer.

The organic layers may include polyurea or polyacrylate.

According to another aspect of the present invention, there is provided a manufacturing method of a flat panel display device, the manufacturing method including: forming a thin film encapsulation structure covering a display unit on a substrate; adhering a protective film onto the thin film encapsulation structure; and subsequently releasing the adhered protective film. Here, the forming of the thin film encapsulation structure includes: forming an alternating layers stack by alternately forming organic layers and inorganic layers; and forming an aluminum oxide (AlOx) layer on the alternating layers stack as an outermost thin film layer onto which the protective film is to be adhered.

A material for forming the inorganic layers may include silicon nitride (SiNx).

The inorganic layer including SiNx may be an outermost layer of the alternating layers stack, and the AlOx layer may be formed on the outermost layer of the alternating layers stack.

The manufacturing method may further include bonding a polarizing plate onto the AlOx layer after the protective film is released.

A material for forming the organic layers may include polyurea or polyacrylate.

According to the above-described embodiments of the flat panel display device and the manufacturing method thereof, a protective film adhered onto the thin film encapsulation structure may be smoothly and suitably released, the thin film encapsulation structure may be prevented from being damaged in the adhering and releasing processes, and thus, a manufacturing error rate of display devices may be reduced.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic cross-sectional view of a flat panel display device including a thin film encapsulation structure, according to an embodiment of the present invention; and

FIGS. 2A through 2F are schematic cross-sectional views for describing a method of manufacturing the flat panel display device illustrated in FIG. 1, according to an embodiment of the present invention.

### DETAILED DESCRIPTION

Hereinafter, the present invention will be described in detail by explaining embodiments of the present invention with reference to the attached drawings. The present invention may, however, be embodied in many different forms and should not be limited to the embodiments set forth herein; rather, these embodiments are provided so that this disclosure will be thorough and complete, and will fully convey the concept of the invention to one of ordinary skill in the art. In addition, when an element is referred to as being “on” another element, it may be directly on the another element or one or more other elements may be interposed therebetween.

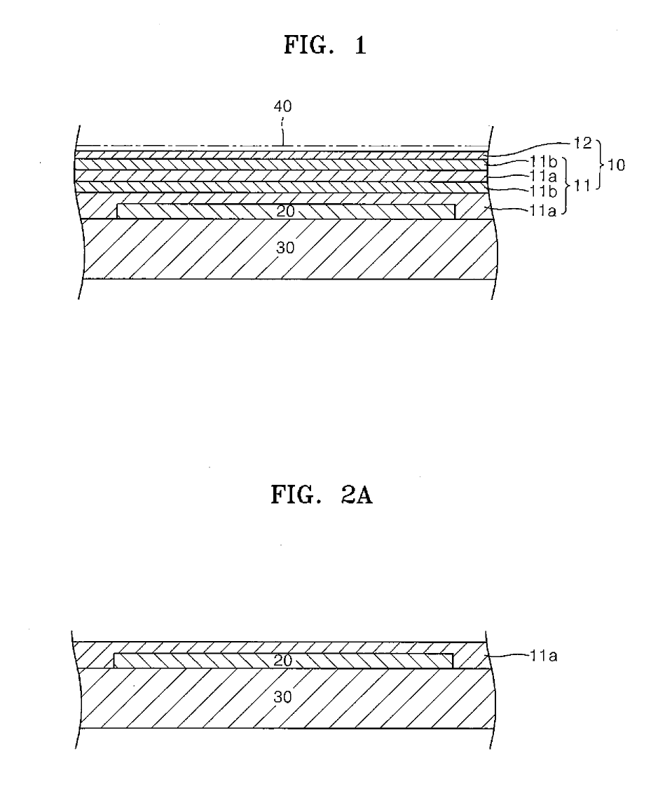

FIG. 1 is a schematic cross-sectional view of a flat panel display device having a thin film encapsulation structure 10, according to an embodiment of the present invention.

As illustrated in FIG. 1, the flat panel display device according to the current embodiment includes a structure in which a display unit 20 for displaying an image is formed on a substrate 30, and the thin film encapsulation structure 10 covers and protects the display unit 20. Reference numeral 40 indicates a polarizing plate bonded onto the thin film encapsulation structure 10.

Here, the thin film encapsulation structure 10 has a structure in which a plurality of thin film layers are stacked, and includes an alternating layers stack (or part or portion) 11, in which organic layers 11a and inorganic layers 11b are alternately stacked, and an aluminum oxide (AlOx) layer 12 formed on the alternating layers stack 11 as an outermost layer.

In the alternating layers stack 11, the inorganic layers 11b prevent (or reduce) penetration of oxygen and/or moisture, and the organic layers 11a absorb (or relieve) stresses of the inorganic layers 11b so as to provide flexibility.

The inorganic layers 11b may be formed of a highly moisture-proof (or moisture-resistant) inorganic material, for example, silicon nitride (SiNx).

The organic layers 11a may be formed of a flexible organic material, for example, polyurea or polyacrylate.

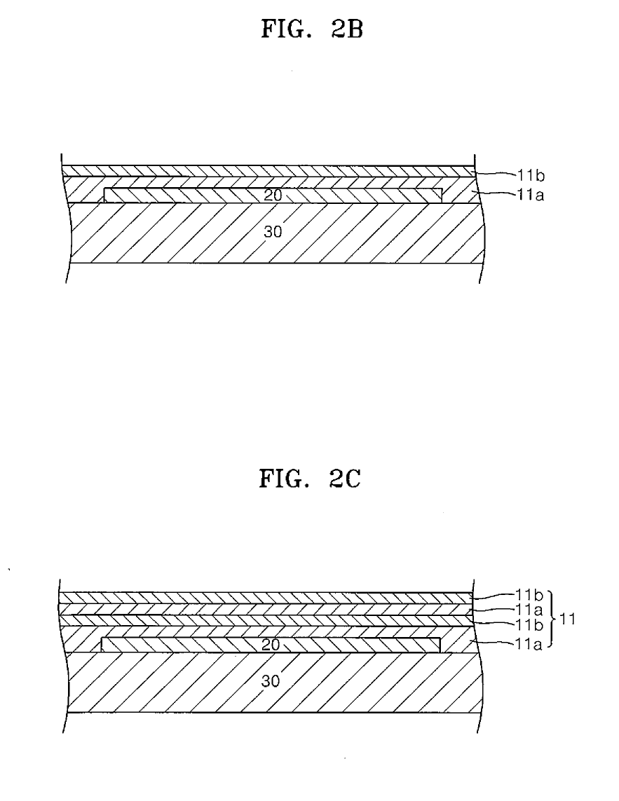

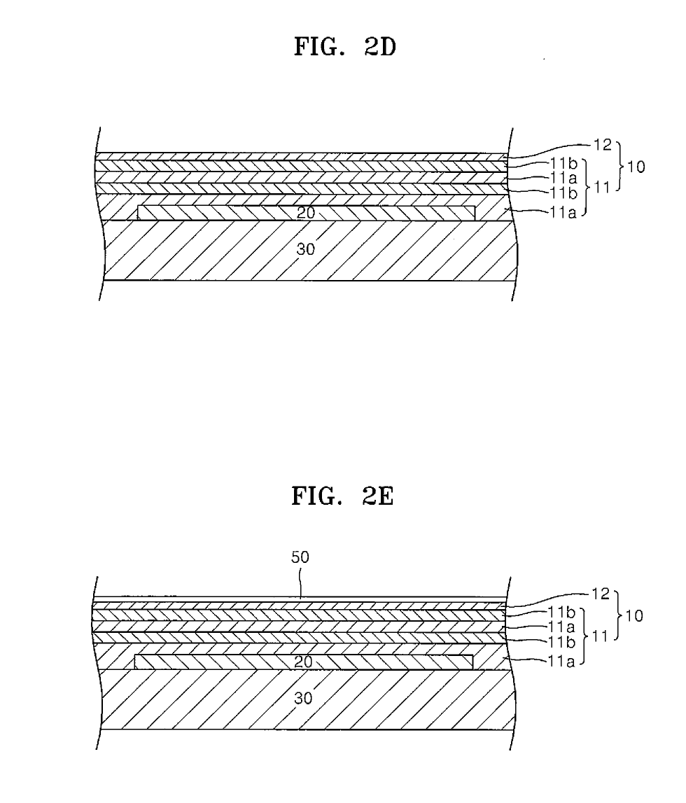

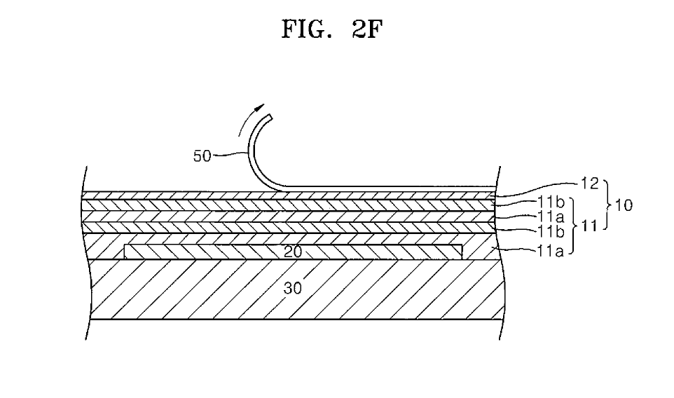

According to one or more embodiments of the present invention, a protective film 50 (see FIG. 2E) is adhered (or attached) onto the thin film encapsulation structure 10, and then is released when the polarizing plate 40 is bonded (or attached) in a subsequent process. The AlOx layer 12 prevents the thin film encapsulation structure 10 from being released together with the protective film 50.

If the AlOx layer 12 is not formed, the inorganic layer 11b formed of, for example, SiNx, is the outermost layer, and the protective film 50 may be adhered onto and then released from the inorganic layer 11b. An adhesive force of SiNx on the protective film 50 is about 15 Gram-force per inch (gf/inch), which is almost triple the adhesive force that AlOx has on the protective film 50 (i.e., about 5.6 gf/inch). Accordingly, if the AlOx layer 12 is not formed and the protective film 50 is adhered onto and then released from the inorganic layer 11b formed of SiNx, due to the above-described strong adhesive force, a portion of the thin film encapsulation structure 10 may also be easily released.

However, if the AlOx layer 12 is the outermost layer of the thin film encapsulation structure 10, as illustrated in FIG. 1, the protective film 50 may be adhered with an adhesive force that is almost ⅓ of the adhesive force when adhered onto SiNx, and thus, may be very smoothly and stably released later.

However, if only the AlOx layer 12 is formed and the inorganic layer 11b formed of, for example, SiNx, is not included, because the thickness of the AlOx layer 12 as the outermost layer may be too small, a gas may leak from the organic layers 11a, which may result in dark spots, and moisture may more easily penetrate into the display unit 20. That is, because the thickness of the AlOx layer 12 is generally very small, the AlOx layer 12 may not solely suitably replace the inorganic layer 11b. Accordingly, if the inorganic layer 11b formed of, for example, SiNx, is the outermost layer of the alternating layers stack 11, and the AlOx layer 12 (onto which the protective film 50 is adhered) is further formed thereon, the function of a strong barrier layer may be achieved and the adhering and releasing processes may suitably be performed.

If the above-described thin film encapsulation structure 10 is included, the inorganic layers 11b may firmly prevent penetration of oxygen and/or moisture from an external environment, the flexible organic layers 11a may absorb stresses of the inorganic layers 11b so as to prevent cracks, and the AlOx layer 12 (as the outermost layer) may allow the protective film 50 to be suitably adhered and released.

The above-described thin film encapsulation structure 10 of the flat panel display device may be manufactured by performing the following processes.

Initially, as illustrated in FIG. 2A, the display unit 20 is formed on the substrate 30, and then the organic layer 11a is formed by using a flexible organic material, for example, polyurea or polyacrylate.

Then, as illustrated in FIG. 2B, the inorganic layer 11b is formed on the organic layer 11a by using, for example, SiNx. As such, the alternating layers stack 11, in which the organic layer 11a and the inorganic layer 11b are alternately stacked, is formed. According to the current embodiment, the above process is repeated once more, and thus, as illustrated in FIG. 2C, two organic layers 11a and two inorganic layers 11b are alternately stacked in the alternating layers stack 11. In this case, the outermost layer of the alternating layers stack 11 is the inorganic layer 11b formed of SiNx.

After that, as illustrated in FIG. 2D, the AlOx layer 12 is formed on the alternating layers stack 11. As such, the thin film encapsulation structure 10, in which the AlOx layer 12 is formed on the alternating layers stack 11 (in which the organic layers 11a and the inorganic layers 11b are alternately stacked), is completely formed.

If the thin film encapsulation structure 10 is completely formed, as illustrated in FIG. 2E, the protective film 50 may be adhered thereon until a subsequent process is performed

After that, when the subsequent process, for example, a process for bonding the polarizing plate 40 is performed, as illustrated in FIG. 2F, the protective film 50 is released. In this case, because the protective film 50 is adhered onto and then released from the AlOx layer 12 (which is the outermost layer of the thin film encapsulation structure 10), an adhesive force is not excessive, and thus, smooth and stable adhering and releasing are possible. That is, a phenomenon of a portion of the thin film encapsulation structure 10 being released together with the protective film 50 does not occur. Then, if the polarizing plate 40 is bonded thereon, the structure illustrated in FIG. 1 is obtained.

Consequently, the thin film encapsulation structure 10, which is stably moisture-proof due to the inorganic layers 11b and is flexible due to the organic layers 11a, onto and from which the protective film 50 is smoothly and stably adhered and released, is achieved.

According to the above-described flat panel display device and the manufacturing method thereof, because a thin film encapsulation structure may safely protect a display unit, and a protective film may be smoothly and stably adhered onto and released from the thin film encapsulation structure, the thin film encapsulation structure may be prevented from being damaged in the adhering and releasing processes, and thus, a manufacturing error rate of display devices may be reduced.

While the present invention has been particularly shown and described with reference to exemplary embodiments thereof, it will be understood by one of ordinary skill in the art that various changes in form and details may be made therein without departing from the spirit and scope of the present invention as defined by the following claims and their equivalents.

What is claimed is:

1. A flat panel display device comprising:
substrate;
display unit on the substrate; and
thin film encapsulation structure comprising a plurality of thin film layers covering the display unit,
wherein the thin film layers of the thin film encapsulation structure comprise:
an alternating layers stack comprising alternately stacked organic layers and inorganic layers; and
an aluminum oxide (AlOx) layer on the alternating layers stack, the AlOx layer being an outermost thin film layer of the thin film encapsulation structure.

2. The flat panel display device of claim 1, wherein the inorganic layers comprise silicon nitride (SiNx).

3. The flat panel display device of claim 2, wherein the inorganic layer comprising SiNx is an outermost layer of the alternating layers stack, and wherein the AlOx layer is on the outermost layer of the alternating layers stack.

4. The flat panel display device of claim 3, wherein a polarizing plate is bonded onto the AlOx layer.

5. The flat panel display device of claim 1, wherein the organic layers comprise polyurea or polyacrylate.

6. A manufacturing method of a flat panel display device, the manufacturing method comprising:
forming a thin film encapsulation structure covering a display unit on a substrate;
adhering a protective film onto the thin film encapsulation structure; and
subsequently releasing the adhered protective film,
wherein the forming of the thin film encapsulation structure comprises:
forming an alternating layers stack by alternately forming organic layers and inorganic layers; and
forming an aluminum oxide (AlOx) layer on the alternating layers stack as an outermost thin film layer onto which the protective film is to be adhered.

7. The manufacturing method of claim 6, wherein a material for forming the inorganic layers comprises silicon nitride (SiNx).

8. The manufacturing method of claim 7, wherein the inorganic layer comprising SiNx is an outermost layer of the alternating layers stack, and
wherein the AlOx layer is formed on the outermost layer of the alternating layers stack.

9. The manufacturing method of claim 8, further comprising bonding a polarizing plate onto the AlOx layer after the protective film is released.

10. The manufacturing method of claim 6, wherein a material for forming the organic layers comprises polyurea or polyacrylate.
